(19) United States
(12) Patent Application Publication
(10) Pub. No.: US 2026/0143254 A1
(43) Pub. Date: May 21, 2026

(54) METHOD AND SYSTEM FOR PROCESSING ANALOGUE SIGNALS DELIVERED BY PIXELS

(71) Applicant: STMICROELECTRONICS INTERNATIONAL N.V., Geneva (CH)

(72) Inventors: Arnaud AUTHIE, Coublevie (FR); Alexis MARCELLIN, Saint-Paul-de-Varces (FR); Vlad ANICULAESEI, Coublevie (FR)

(21) Appl. No.: 19/366,826

(22) Filed: Oct. 23, 2025

(30) Foreign Application Priority Data
Oct. 28, 2024 (FR) 2411747

(51) Int. Cl. H04N 25/616; H04N 25/77

(52) U.S. Cl. CPC H04N 25/616; H04N 25/77

(57) ABSTRACT

A method for processing an analogue signal is provided. An example includes a method for processing an analogue signal from a pixel using a correlated double sampling method including two successive measurements of durations between the instant of start of a ramp signal and the instant where the pixel signal crosses the ramp. A single counting circuit is used for the two measurements and in particular a single counter that will provide the two counting values used for generating the least significant bits of the output digital word representative of the amount of light captured by the pixel.

### CROSS REFERENCE TO RELATED APPLICATION(S)

This application claims the priority benefit of French patent application number FR2411747, filed on Oct. 28, 2024, entitled “PROCEDE ET SYSTEME DE TRAITEMENT DE SIGNAUX ANALOGIQUES DELIVRES PAR DES PIXELS”, which is hereby incorporated by reference to the maximum extent allowable by law.

### TECHNICAL FIELD

The present disclosure relates to the processing of analogue signals, particularly the processing of analogue signals delivered by pixels using Correlated Double Sampling (CDS), and in particular the reduction or even the elimination of the Vertical Fixed Pattern Noise (VFPN), which translates into vertical bands in images.

### BACKGROUND

The processing of an analogue signal from a pixel using the so-called correlated double sampling method, comprises two consecutive steps of, namely:
comparing the signal delivered by the pixel, in this case a voltage, with a reference ramp signal,
measuring the duration between the start of the ramp and the instant of crossing of the ramp with the signal delivered by the pixel.

These two steps are carried out twice:
a first time with the non-illuminated pixel having a reference state, typically the black level thereof,
a second time with the illuminated pixel.

The difference between the two measurement durations is representative of the amount of light captured by the pixel.

Determining the two measurement durations conventionally comprises using different counters to count periods of a clock signal.

Yet, even if these different counters are structurally identical, the components present in these counters have mismatches resulting from the manufacturing method thereof.

Furthermore, the use of different counters requires the use of material signal propagation paths to these counters, which induces different propagation delays between the same signals conveyed during the two measurements whereas they are initiated at the same instant during these two measurements.

These mismatches and these different propagation delays induce errors in measuring the amount of light captured by the pixel.

In general, an image sensor includes an array of pixels organised in rows and columns.

The array is read row by row, all of the pixels of the same row being read simultaneously from reading devices including these different counters and respectively disposed at the bottom of each column.

The measurement errors mentioned above may vary from one pixel to another along a row, which produces the abovementioned VFPN noise.

There is therefore a need to provide a solution that aims to reduce or even eliminate this VFPN noise.

### BRIEF SUMMARY

According to one implementation and embodiment, it is proposed to use a single counting circuit to carry out the two measurements mentioned above, and in particular a single counter to determine the least significant bits of the output digital word representative of the amount of light captured by a pixel.

According to one aspect, a method for processing an analogue signal from a pixel using a so-called correlated double sampling method is proposed.

This method comprises a first comparison of the signal corresponding to a reference state, for example a black level, of the non-illuminated pixel, with a ramp type signal and a first measurement of a first duration between the start of the ramp signal and a first instant where the signal crosses the ramp signal.

This first measurement is followed by a second comparison of the analogue signal corresponding to the illuminated pixel with the ramp signal and a second measurement of a second duration between the start of the ramp signal and a second instant where the signal crosses the ramp signal.

The method also comprises generating an output digital word corresponding to a subtraction of the second duration and of the first duration.

This output digital word is representative of the amount of light captured by the pixel.

In the method according to this aspect, the first measurement, the second measurement and the generation of the output digital word comprise counts in the same circuit for counting the number of periods of a basic clock signal between the start of the ramp signal and each of the first and second instants.

Thus, instead of using different counting circuits for the two measurements (non-illuminated pixel and illuminated pixel) and in particular two different counters for generating the least significant bits that in particular includes a subtraction between the two counting values), a single counting circuit is used here for the two measurements and in particular a single counter that will provide the two counting values used for generating the least significant bits of the output digital word.

Any measurement error is thus eliminated by using a single counting circuit.

More precisely and according to one implementation, the counting circuit includes
a first counter successively delivering a first digital word at the end of a first count between the start of the ramp signal and the first instant and a second digital word at the end of a second count between the start of the ramp signal and the second instant, and
a second counter controlled by the first counter during the first count and during the second count and delivering a third digital word at the end of the second count.

Generating the output digital word then includes
generating at least one least significant bit of the output digital word from the first digital word and from the second digital word, and
generating the other bits of the output digital word (the most significant bits) from the third digital word.

Although it would be possible to generate only a single least significant bit of the output digital word, generating the output digital word includes generating a plurality of least significant bits of the output digital word from the first digital word and from the second digital word.

Although it would be possible to carry out a subtraction of the second and first digital words, for example if they were binary coded, it is advantageous to use a thermometric code to code the first and second digital words.

In this case, generating the least significant bit(s) of the output digital word includes, for example, generating a first intermediate digital word (advantageously coded in binary) from the first digital word (advantageously coded in thermometric code) and a second intermediate digital word (advantageously coded in binary) from the second digital word (advantageously coded in thermometric code), and
subtracting the second and first intermediate digital words so as to obtain the least significant bit(s) of the output digital word.

The use of a thermometric code is advantageous because one value passes to another by changing only one bit.

In addition as indicated above, when the first digital word and the second digital word are coded according to a thermometric code, the first intermediate digital word and the second intermediate digital word are coded according to a binary code and generating the first and second intermediate digital words then includes converting the thermometric code into a binary code.

According to one implementation, the first digital word and the second digital word are words coded on N bits according to a thermometric code corresponding to 2N decimal values.

The first counter then includes N first flip-flops, for example D flip-flops.

The method then comprises, according to one implementation, generating N additional clock signals mutually phase shifted by a base period of the basic clock signal and each having a period equal to 2N times the base period.

The first count (with the non-illuminated pixel) includes:
delivering as input of the N first flip-flops, successive groups of N binary data corresponding respectively to the logic states (high or low) of the N additional clock signals present at the input of these N first flip-flops,
extracting the N first binary data contained in these N first flip-flops at the expiration of the first duration (that is to say when the pixel signal crosses the ramp signal), and
saving these N first binary data in respectively N second flip-flops, for example also D flip-flops.

The second count (with the illuminated pixel) includes:
delivering as input of the N first flip-flops, successive groups of N binary data corresponding respectively to the logic states of the N additional clock signals present at the input of these N first flip-flops, and
saving the N second binary data contained in these N first flip-flops at the expiration of the second duration (this saving is advantageously carried out in the N first flip-flops).

The method then comprises delivering, at the end of the second count,
N first binary data as output of the N second flip-flops, so as to form the first digital word, and
N second binary data as output of the N first flip-flops, so as to form the second digital word.

According to one implementation, the first count includes incrementing the second counter each time the N binary data contained in the N first flip-flops correspond to a maximum logic value, and
the second count includes decrementing the second counter each time the N binary data contained in the N first flip-flops correspond to a maximum logic value,
the binary data delivered by the second counter at the end of the second count forming the bits of the third digital word.

In other words, the subtraction of the count values between the two measurements is carried out directly in the second counter by the successive incrementation and decrementation operations.

According to another aspect, a system for processing an analogue signal from a pixel using a so-called correlated double sampling method is proposed.

This system comprises:
a signal input for receiving the analogue signal from the pixel,
a ramp generator for delivering a ramp type signal, and processing means.

These processing means are configured to
carry out a first comparison of the signal corresponding to a reference state of the non-illuminated pixel with the ramp type signal and a first measurement of a first duration between the start of the ramp signal and a first instant where the signal crosses the ramp signal, followed by a second comparison of the signal corresponding to the illuminated pixel with the ramp signal and a second measurement of a second duration between the start of the ramp signal and a second instant where the signal crosses the ramp signal, and
generate an output digital word corresponding to a subtraction of the second duration and of the first duration.

In the system according to this aspect, the processing means are configured to carry out the first measurement, the second measurement and to generate the output digital word from counts in the same counting circuit, of the number of periods of a basic clock signal between the start of the ramp signal and each of the first and second instants.

According to one embodiment, the counting circuit includes
a first counter configured to successively deliver a first digital word at the end of a first count between the start of the ramp signal and the first instant then a second digital word at the end of a second count between the start of the ramp signal and the second instant, and
a second counter controlled by the first counter during the first count and during the second count and configured to deliver a third digital word at the end of the second count.

The processing means include
first generation means configured to generate at least one least significant bit of the output digital word from the first digital word and from the second digital word, and
second generation means configured to generate the other bits of the output digital word from the third digital word.

According to one embodiment, the first generation means are configured to generate a plurality of least significant bits of the output digital word from the first digital word and from the second digital word.

According to one embodiment, the first generation means include
a module configured to generate a first intermediate digital word from the first digital word and a second intermediate digital word from the second digital word, and
a subtractor configured to carry out a subtraction of the second and of the first intermediate digital words so as to obtain the least significant bit(s) of the output digital word.

When the first digital word and the second digital word are coded according to a thermometric code, the first intermediate digital word and the second intermediate digital word are coded according to a binary code and the module is configured to carry out a conversion of the thermometric code into a binary code.

According to one embodiment, the first digital word and the second digital word are words coded according to a thermometric code on N bits corresponding to 2N, decimal values.

The processing means further comprise a control block configured to deliver
a first control signal at the first instant,
a second control signal at the second instant,
a third control signal between the first instant and the delivery of the trigger signal.

The processing means further comprise a generation circuit configured to generate
N additional clock signals mutually phase shifted by a base period of the basic clock signal and each having a period equal to 2N times the base period, and
a trigger signal intended to trigger the ramp generator.

The first counter advantageously includes N counting inputs respectively capable of receiving successive groups of N binary data corresponding respectively to the logic states of the N additional clock signals present at the N counting inputs and N first flip-flops having the inputs thereof respectively connected to the N counting inputs, and configured to freeze in the presence of the first control signal (that is to say at the first instant when the non-illuminated pixel signal crosses the ramp signal), the N first binary data received at the respective inputs thereof.

The processing means also advantageously include N second flip-flops having the inputs thereof respectively connected to the outputs of the N first flip-flops and configured to store the N first binary data, in the presence of the third control signal.

In other words, there is then a transfer of the N first data from the N first flip-flops to the N second flip-flops and the n first flip-flops are again available for the second count with the illuminated pixel.

Thus, according to one implementation, during the second count, the N counting inputs are respectively capable of again receiving successive groups of N binary data corresponding respectively to the logic states of the N additional clock signals present at the N counting inputs, and the N first flip-flops of the first counter are then configured to freeze in the presence of the second control signal (that is to say at the second instant when the illuminated pixel signal crosses the ramp signal), the N second binary data received at the respective inputs thereof.

The control block is configured to deliver control information
to the first flip-flops to extract the N second binary data frozen in the N first flip-flops, so as to form the second digital word, and
to the second flip-flops to extract the stored N first binary data, so as to form the first digital word.

According to one embodiment, the generation circuit is configured to deliver the signal for triggering the ramp when the N binary data present at the N counting inputs of the first counter correspond to a maximum logic value.

According to one embodiment:
during the first count by the first counter, the second counter is configured to be incremented each time the N binary data contained in the N first flip-flops correspond to a maximum logic value, and
during the second count by the first counter, the second counter is configured to be decremented each time the N binary data contained in the N first flip-flops correspond to a maximum logic value.

The binary data delivered by the second counter at the end of the second count form the bits of the third digital word.

According to another aspect, a sensor is proposed including an array of pixels organised in rows and columns, and including respectively at the bottom of each column, a system as defined above.

### BRIEF DESCRIPTION OF THE DRAWINGS

Other advantages and features of the present disclosure will appear upon examining the detailed description of non-limiting modes of implementation and embodiments, and from the appended drawings, wherein:

FIGS. 1-7 illustrate implementations and embodiments of the present disclosure.

### DETAILED DESCRIPTION

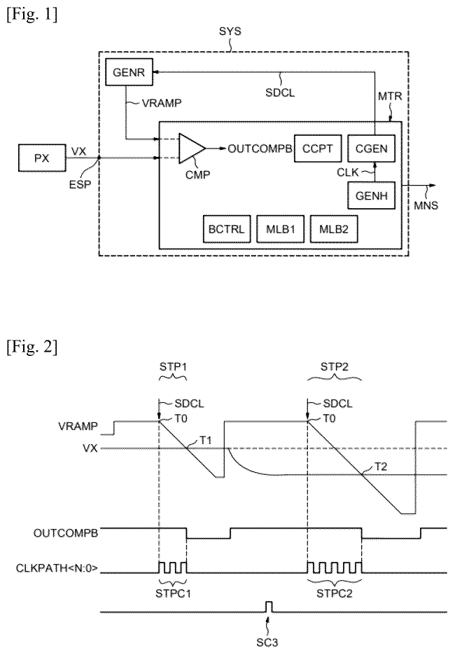

In FIG. 1, the reference SYS designates a system for processing an analogue signal VX from a pixel PX using a so-called correlated double sampling method.

The pixel PX has a conventional structure known per se that will not be detailed here.

The reference VX designates the signal or voltage delivered by the pixel during the reading thereof.

The system SYS comprises:
a signal input ESP for receiving the analogue signal VX from the pixel, and
a ramp generator GENR for delivering a ramp VRAMP type signal of predetermined features.

This ramp signal VRAMP is used conventionally to determine the value of the pixel signal PX.

The system SYS also comprises processing means MTR.

Generally, these processing means MTR are configured to, in a first step STP1 (FIG. 2), known as the calibration step, carry out a first comparison of the signal VX corresponding to a reference state of the non-illuminated pixel, for example a black level, with the ramp type signal VRAMP and a first measurement of a first duration between the start T0 of the ramp signal and a first instant T1 where the signal crosses the ramp signal.

This first step STP1 is followed by a second step STP2, wherein the processing means are configured to carry out a second comparison of the signal VX corresponding to the illuminated pixel, with the ramp signal VRAMP and a second measurement of a second duration between the start T0 of the ramp signal and a second instant T2 where the signal crosses the ramp signal.

The processing means are then configured to generate an output digital word MNS corresponding to a subtraction of the second duration and of the first duration.

This output digital word MNS is representative of the amount of light captured by the pixel.

It may already be noted that the processing means MTR are configured to carry out the first measurement, the second measurement and to generate the output digital word from counts in a single counting circuit CCPT of the number of periods of a basic clock signal CLK (having a base period) between the start T0 of the ramp signal and each of the first and second instants T1, T2.

As will be seen in more detail below, these counts of the number of periods of the basic clock signal CLK are carried out by using additional clock signals mutually phase shifted by a base period of the basic clock signal and each having a period equal to a multiple of the base period.

To carry out the various operations mentioned above,
the processing means include (FIG. 1)
a comparator CMP configured to carry out the comparison between the ramp signal VRAMP and the pixel signal VX and deliver a comparison signal OUTCOMPB,
a clock generator GENH configured to generate a basic clock signal CLK, typically having a high frequency,
a generation circuit CGEN configured to generate the additional clock signals CLKPATH<i> (here N additional clock signals CLKPATH<i> with i variant of 1 to N) as well as a signal SDCL for triggering the ramp generator GENR,
a counting circuit CCPT,
first generation means MLB1 configured to generate a plurality of least significant bits of the output digital word MNS,
second generation means MLB2 configured to generate the other bits of output bits, the most significant bits of the output digital word MNS,
a control block BCTRL configured to deliver a plurality of control signals.

The structure and/or the functionality of some of these means will be discussed in greater detail below.

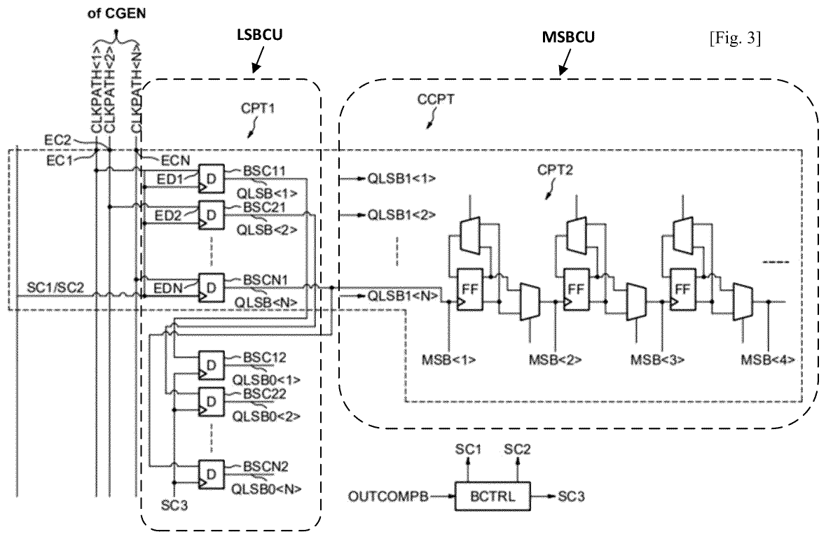

Reference is now made more particularly to FIG. 2 and FIG. 3.

The method includes (FIG. 2) a first count STPC1 between the start T0 of the ramp signal VRAMP and the first instant T1 and a second count STPC2 between the start T0 of the ramp signal VRAMP and the second instant T2.

A control signal SC3, in the form of a pulse, is delivered by the control block BCTRL between the first instant T1 and the occurrence of the trigger signal SDCL marking the start of the second count STPC2 and the triggering of the ramp signal GENR.

The signal OUTCOMPB of the comparator is in the high state (logic value 1) during counting and passes to the low state (logic value 0) when the ramp signal VRAMP crosses the pixel signal VX, marking the end of the counting.

As illustrated schematically in FIG. 3, the counting circuit CCPT includes a first counter CPT1 successively delivering a first digital word QLSB0<N:1> at the end of the first count STPC1 and a second digital word QLSB1<N:1> at the end of the second count STPC2.

The least significant bits of the output digital word are generated from the first digital word QLSB0<N:1> and from the second digital word QLSB1<N:1>.

The counting circuit CCPT also includes a second counter CPT2, controlled by the first counter CPT1 during the first count and during the second count, and delivering a third digital word MSB<M:1> at the end of the second count.

The other bits of the output digital word (the most significant bits) are generated from the third digital word.

The first digital word QLSB0<N:1> and the second digital word QLSB1<N:1> are formed of N bits and are coded according to a digital thermometric code corresponding to 2N decimal values.

This is why N additional clock signals CLKPATH<N:1> are used, each having a period equal to 2N base periods of the basic clock signal CLK, to carry out the two successive counts.

If reference is more particularly made to FIG. 3, it can be seen that the first counter CPT1 includes N counting inputs EC1, EC1, EC2, ECN respectively capable of receiving successive groups of N binary data corresponding respectively to the logic states of the N additional clock signals CLKPATH<1>, CLKPATH<2>, CLKPATH<N> present at the N counting inputs.

The first counter CPT1 also includes N first flip-flops BSC11, BSC21, . . . , BSCN1 having the data inputs ED1, ED2, . . . , EDN thereof respectively connected to the N counting inputs.

These first flip-flops here are flip-flops synchronised on the low level of the first signal SC1 (during the first count) and on the low level of the second signal SC2 (during the second count).

These signals SC1 and SC2 are the opposite of the signal OUTCOMPB.

In other words, as long as the signal OUTCOMPB is at the high level (signal SC1 or SC2 at the low level), each first flip-flop BSCi1 is “transparent”, that is to say copies the input CLKPATH<i> thereof to the output QLSB<i> thereof.

On the other hand, when the signal OUTCOMPB passes to the low state (signal SC1 or SC2 in the high state), each first flip-flop “closes”, leading to storing at the output of the flip-flop, the last value at the input of this first flip-flop.

In other words, the passage to the high state of the signal SC1, during the first count, corresponds to a first control signal freezing the N first binary data received on the respective data inputs of the first flip-flops.

These N first binary data are referenced QLSB 0<N:1> and form the first digital word.

The passage to the high state of the signal SC2, during the second count, corresponds to a second control signal freezing the N second binary data received on the respective data inputs of the first flip-flops.

These N second binary data are referenced QLSB 1<N:1> and form the second digital word.

The processing means also include N second D flip-flops referenced BSC12, BSC22, . . . , BSCN2, having the data inputs thereof respectively connected to the outputs of the N first flip-flops BSC11, BSC21, . . . , BSCN1.

These N second flip-flops are synchronised on the low level of the third signal SC3.

When this pulse signal SC3 passes to the high level, it acts as a third control signal and these N second flip-flops then store the N first binary data QLSB 0<N:1>.

In other words, there is then a transfer of the N first binary data QLSB 0<N:1> from the N first flip-flops BSCi1 to the N second flip-flops BSCi2 and the N first flip-flops BSCi1 are again available for the second count with the illuminated pixel.

The second counter CPT2 is a counter of conventional and known structure and includes looped flip-flops FF connected in series.

This second counter CPT2 is controlled by the output of the first flip-flop BSCN1 of the first counter CPT1.

When the data QLSB<N> of this first flip-flop is equal to 1, which corresponds to a maximum value for the N data received by these N first flip-flops, the second counter CPT2 is incremented during the first count and decremented during the second count.

As a result, at the end of the second count it delivers the bits MSB<M:1> of the third digital word.

As illustrated in FIG. 3, various embodiments may include a least significant bit(s) (LSB) counter unit (LSBCU) and a most significant bit(s) (MSB) counter unit (MSBCU). The LSBCU may perform two functions, counting and saving. Counting may be performed by block1 (BSCN1). Saving may be performed by block 1 (BSCN1) and block 2 (BSCN2). In a double counting process, the BSCN1 counts on both ramps. BSCN1 stores and transmitted the counted value for ramp2, and BSCN2 records and transmitted the counted value for ramp1. The MSBCU block receives the output from BSCN1 during the successive counts of ramps 1 and 2 and performs the up-counting/down-counting operation(s) for the MSB part of the converted signal.

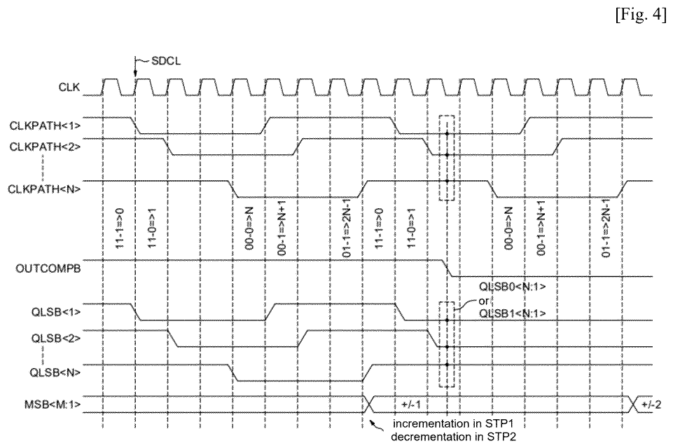

Reference is now made more particularly to FIG. 4 that illustrates a partial timing diagram relating to the first count or to the second count.

The trigger signal SDCL triggers the generator GENR of the ramp signal on the falling edge of the additional clock signal CLKPATH<1>, that is to say just after the N signals CLKPATH<N:1> have all had the high state thereof.

The signals CLKPATH<N:1> are then delivered to the counting inputs of the first counter CPT1.

The successive values of the N binary data QLSB<N:1> then correspond to the successive states of the signals CLKPATH<N:1>.

Each time that CLKPATHN passes to the high state, the second counter CPT2 is incremented in step STP1 (during the first count) whereas it is decremented in step STP2 (during the second count).

This continues up to the falling edge of OUTCOMPB.

At the falling edge of OUTCOMPB, the first flip-flops BSCi1 (during the first count) close and the first binary data QLSB 0<N:1> (at the end of the first count) are stored and transferred into the N second flip-flops in response to the third control signal SC3.

Then what has just been described is repeated during the second count up to the falling edge of OUTCOMPB.

At the falling edge of OUTCOMPB, the first flip-flops BSCi1 (during the second count) close and the second binary data QLSB 1<N:1> (at the end of the second count) are stored in these first flip-flops.

Of course, the values of the first and second stored binary data are generally different.

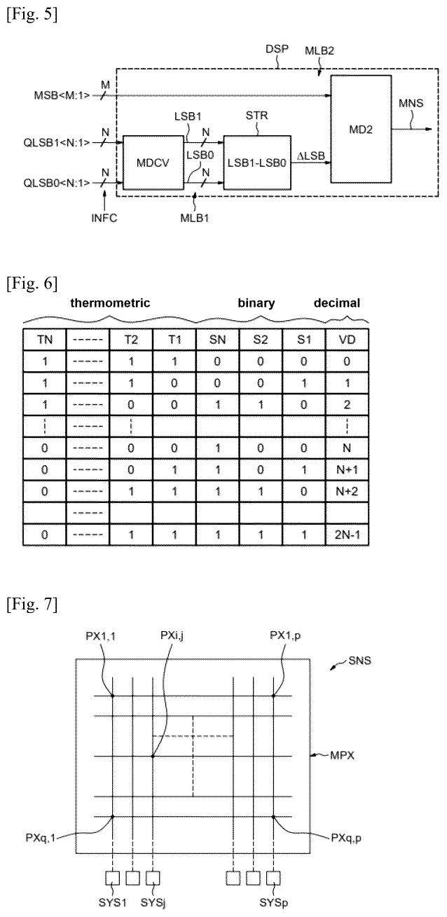

Reference is now made more particularly to FIG. 5 to describe one embodiment of the first generation means MLB1 and of the second generation means MLB2, which are incorporated within a processing unit DSP, for example a signal processor.

In response to control information INFC delivered by the control block, the first digital word QLSB<N:1> and the second digital word QLSB 1<N:1> are extracted from the corresponding flip-flops and the third digital word MSB<M:1> is delivered by the second counter CPT2.

The first generation means MLB1 receive the first digital word QLSB<N:1> and the second digital word QLSB 1<N:1>, coded according to a thermometric code.

They include a module MDCV configured to generate a first intermediate digital word LSB0 from the first digital word and a second intermediate digital word LSB1 from the second digital word.

These two intermediate digital words are coded in binary.

The module is therefore configured to carry out a conversion of the thermometric code into a binary code, according to the conventional conversion table illustrated in FIG. 6.

In this table, T1, T2, . . . , TN designate the N bits of the thermometric code.

S1, S2, . . . , SN designate the corresponding N bits of the binary code and VD designates the corresponding decimal value.

The first generation means also include a subtractor STR configured to carry out a subtraction LSB1-LSB0 of the second LSB1 and of the first LSB0 intermediate digital words so as to obtain the least significant bit(s) ΔLSB of the output digital word MNS.

The second generation means here include a second module MD2 possibly multiplying the bits MSB<M:1> by an integer as a function of the desired resolution.

The bits of the output digital word MNS delivered by the second module MD2 include the least significant bits ΔLSB and the most significant bits MSB<M:1> possibly multiplied by the integer.

FIG. 7 schematically illustrates a sensor SNS including an array MPX of pixels PXI, j here having q rows and p columns.

The pixels of a row are read simultaneously using the method that has just been described.

Then we go to the next row until the entire array is read.

Consequently, the sensor SNS includes respectively at the bottom of the p columns, p systems SYS1-SYSp identical to the system SYS described with reference to FIGS. 1 to 6.

1. A method for processing an analogue signal from a pixel using a correlated double sampling method comprising:
comparing, in a first comparison, a signal corresponding to a reference state of a non-illuminated pixel with a ramp type signal and a first measurement of a first duration between a start of the ramp type signal and a first instant where the signal crosses the ramp type signal;
comparing, in a second comparison following the first comparison, of a signal corresponding to an illuminated pixel with the ramp type signal and a second measurement of a second duration between the start of the ramp type signal and a second instant where the signal crosses the ramp type signal; and
generating an output digital word corresponding to a subtraction of the second duration and of the first duration, the first measurement, the second measurement and generating of the output digital word comprise counts in a same circuit for counting a number of periods of a basic clock signal between the start of the ramp type signal and each of the first instant and second instant.

2. The method of claim 1, wherein a counting circuit comprises:
a first counter successively delivering a first digital word at an end of a first count between the start of the ramp type signal and the first instant and a second digital word at the end of a second count between the start of the ramp type signal and the second instant; and
a second counter controlled by the first counter during the first count and during the second count and delivering a third digital word at an end of the second count; and
wherein generating the output digital word comprises:
generating at least one least significant bit of the output digital word from the first digital word and from the second digital word; and
generating one or more other bits of the output digital word from the third digital word.

3. The method of claim 2, wherein generating the output digital word comprises generating a plurality of least significant bits of the output digital word from the first digital word and from the second digital word.

4. The method of claim 2, wherein generating the at least one least significant bit from the output digital word comprises generating a first intermediate digital word from the first digital word and a second intermediate digital word from the second digital word; and
wherein subtracting the second intermediate digital word and first intermediate digital word to obtain the at least one least significant bit of the output digital word.

5. The method of claim 4, wherein the first digital word and the second digital word are coded according to a thermometric code;
wherein the first intermediate digital word and the second intermediate digital word are coded according to a binary code; and
wherein generating the first intermediate digital word and second intermediate digital word comprises converting the thermometric code into a binary code.

6. The method of claim 3, wherein the first digital word and the second digital word are words coded on N bits corresponding to 2N decimal values;
wherein the first counter includes N first flip-flops;
wherein the method comprises generating N additional clock signals mutually phase shifted by a base period of the basic clock signal and each having a period equal to 2N times the base period;
wherein the first count includes delivering as input the N first flip-flops, successive groups of N binary data corresponding respectively to one or more logic states of the N additional clock signals present at the input of these N first flip-flops, extracting an N first binary data contained in these N first flip-flops at an expiration of the first duration and saving these N first binary data in respective N second flip-flops;
wherein the second count includes delivering as input the N first flip-flops, successive groups of N binary data corresponding respectively to the one or more logic states of the N additional clock signals present at the input of these N first flip-flops, saving an N second binary data contained in these N first flip-flops at the expiration of the second duration; and
wherein the method comprises delivering at the end of the second count, the N first binary data and the N second binary data respectively as output of the respective N second flip-flops and of the N first flip-flops, so as to form respectively the first digital word and the second digital word.

7. The method of claim 6, wherein the first count comprises incrementing the second counter each time an N binary data contained in the N first flip-flops correspond to a maximum logic value;
wherein the second count includes decrementing the second counter each time the N binary data contained in the N first flip-flops correspond to a maximum logic value; and
wherein a binary data delivered by the second counter at the end of the second count forming one or more bits of the third digital word.

8. A system for processing an analogue signal from a pixel using a correlated double sampling method comprising:
a signal input for receiving a signal;
a ramp generator for delivering a ramp type signal;
a processing means configured to:
compare, with a first comparison, a signal corresponding to a reference state of a non-illuminated pixel with the ramp type signal and a first measurement of a first duration between a start of the ramp type signal and a first instant where the signal crosses the ramp type signal;
compare, in a second comparison following the first comparison, the signal corresponding to an illuminated pixel with the ramp type signal and a second measurement of a second duration between the start of the ramp type signal and a second instant where the signal crosses the ramp type signal; and
generate an output digital word corresponding to a subtraction of the second duration and of the first duration; and
wherein the processing means are configured to carry out the first measurement, to carry out the second measurement, and to generate the output digital word from counts, in a counting circuit, of a number of periods of a basic clock signal between the start of the ramp type signal and each of the first instant and the second instant.

9. The system of claim 8, wherein the counting circuit comprises:
a first counter configured to successively deliver a first digital word at an end of a first count between the start of the ramp type signal and the first instant then a second digital word at the end of a second count between the start of the ramp type signal and the second instant, and
a second counter controlled by the first counter during the first count and during the second count and configured to deliver a third digital word at the end of the second count, comprises:
a first generation means configured to generate at least one least significant bit of the output digital word from the first digital word and from the second digital word, and
a second generation means configured to generate one or more other bits of the output digital word from the third digital word.

10. The system of claim 9, wherein the first generation means are configured to generate a plurality of least significant bits of the output digital word from the first digital word and from the second digital word.

11. The system of claim 9, wherein the first generation means include:
a module configured to generate a first intermediate digital word from the first digital word and a second intermediate digital word from the second digital word; and
a subtractor configured to carry out a subtraction of the second intermediate digital word and of a first intermediate digital word to obtain the at least one least significant bit of the output digital word.

12. The system of claim 11, wherein the first digital word and the second digital word are coded according to a thermometric code;
wherein the first intermediate digital word and the second intermediate digital word are coded according to a binary code; and
wherein the module is configured to carry out a conversion of the thermometric code into a binary code.

13. The system of claim 10, wherein the first digital word and the second digital word are words coded on N bits corresponding to 2N decimal values;
wherein the processing means further comprise a control block configured to:
deliver a first control signal at the first instant;
deliver a second control signal at the second instant;
deliver a third control signal between the first instant and a delivery of a trigger signal;
wherein the processing means further comprise a generation circuit configured to:
generate N additional clock signals mutually phase shifted by a base period of the basic clock signal and each having a period equal to 2N times the base period; and
generate a trigger signal intended to trigger the ramp generator.

14. The system of claim 13, wherein the first counter includes N counting inputs respectively capable of receiving successive groups of N binary data corresponding respectively to one or more logic states of the N additional clock signals present at the N counting inputs and N first flip-flops having one or more inputs thereof respectively connected to the N counting inputs, and configured to freeze in a presence of the first control signal, an N first binary data received at the respective one or more inputs thereof; and
wherein the processing means also include N second flip-flops having the one or more inputs thereof respectively connected to one or more outputs of the N first flip-flops and configured to store the N first binary data, in the presence of the third control signal.

15. The system of claim 14, wherein the N first flip-flops of the first counter are configured to freeze in the presence of the second control signal, an N second binary data received at the respective one or more inputs thereof, and the control block is configured to deliver control information to the N first flip-flops to extract the N second binary data frozen in the N first flip-flops, so as to form the second digital word; and
wherein the N second flip-flops to extract the N first binary data stored, so as to form the first digital word.

16. The system of claim 13, wherein the generation circuit is configured to deliver the trigger signal when a N binary data present at one or more N counting inputs of the first counter correspond to a maximum logic value.

17. The system of claim 9, wherein during the first count by the first counter, the second counter is configured to be incremented each time an N binary data contained in one or more N first flip-flops correspond to a maximum logic value; and
wherein during the second count by the first counter, the second counter is configured to be decremented each time the N binary data contained in the one or more N first flip-flops correspond to a maximum logic value, wherein a binary data delivered by the second counter at the end of the second count forming one or more bits of the third digital word.

18. A sensor comprising:
an array of pixels organized in one or more rows and one or more columns; and
for each of the one or more columns, the system of claim 8 at a bottom of each respective column of the one or more columns.
